(19) United States
(12) Patent Application Publication
(10) Pub. No.: US 2013/0147292 A1
(43) Pub. Date: Jun. 13, 2013

(54) COOLING PLATE FOR ELECTRIC MOTOR WITH IMPROVED HEAT RADIATION CAPABILITY

(71) Applicant: Fanuc Corporation, Yamanahsi (JP)

(72) Inventors: SeungJun LEE, Minamitsuru-gun (JP); Hidetoshi UEMATSU, Minamitsuru-gun (JP)

(73) Assignee: FANUC CORPORATION, Yamanashi (JP)

(21) Appl. No.: 13/676,636

(22) Filed: Nov. 14, 2012

(30) Foreign Application Priority Data
Dec. 9, 2011 (JP) 2011-270556

(51) Int. Cl. H02K 9/00

(52) U.S. Cl. CPC H02K 9/00
USPC 310/59

(57) ABSTRACT

In accordance with the present invention, there is provided a cooling plate including a plurality of plate members stacked on one another between an electric motor and a coupled body to which the electric motor is coupled, wherein at least one of the plurality of plate members has a penetration groove extending through the plate member in a thickness direction and extending in the plate member in a plane direction orthogonal to the thickness direction, the penetration groove defining a coolant supply channel for supplying a coolant.

### BACKGROUND OF THE INVENTION

1. Field of the Invention

The present invention relates to a cooling plate for an electric motor for dissipating heat generated by the electric motor.

2. Description of the Related Art

In a machine using an electric motor, such as a machine tool, heat generated by the electric motor is conducted via an interconnection of the electric motor to other parts of the machine. Some parts of the machine may be thermally deformed to the extent that cannot be neglected due to the heat generated by the electric motor. This may result in impaired accuracy in machine processing. In order to address this issue, a technique has been known, in which a cooling plate is interposed between an electric motor and other parts of a machine so as to reduce heat conducted from the electric motor (see JP-A-2011-51027).

Thus, there is a need to provide a cooling plate for an electric motor which can effectively reduce heat conducted from the electric motor.

### SUMMARY OF THE INVENTION

In accordance with a first aspect of the present invention, there is provided a cooling plate comprising a plurality of plate members stacked on one another between an electric motor and a coupled body to which the electric motor is coupled, wherein at least one of the plurality of plate members has a penetration groove extending through the plate member in a thickness direction and extending in the plate member in a plane direction orthogonal to the thickness direction, the penetration groove defining a coolant supply channel for supplying a coolant.

In accordance with a second aspect of the present invention, there is provided the cooling plate according to the first aspect, wherein at least two of the plurality of plate members have the penetration groove, the penetration grooves being in communication with one another and forming the coolant supply channel.

In accordance with a third aspect of the present invention, there is provided the cooling plate according to the first or the second aspect, further comprising seal means for sealing the coolant supply channel.

In accordance with a fourth aspect of the present invention, there is provided the cooling plate according to any one of the first to the third aspects, wherein one of the plurality of plate members situated opposite to the electric motor has a surface adapted to an opposite surface shape of the electric motor, and wherein one of the plurality of plate members situated opposite to the coupled body has a surface adapted to an opposite surface shape of the coupled body.

In accordance with a fifth aspect of the present invention, there is provided the cooling plate according to any one of the first to the fourth aspects, further comprising a receiving portion for receiving fixing means for fixing the electric motor, the cooling plate and the coupled body to one another.

These and other objects, features and advantages of the present invention will be more apparent in light of the detailed description of exemplary embodiments thereof as illustrated by the drawings.

### BRIEF DESCRIPTION OF THE DRAWINGS

FIG. 1 is a perspective view showing a cooling plate according to an embodiment of the present invention as mounted to an electric motor and a mounting frame;

FIG. 2A is a side view showing the cooling plate according to the embodiment of the present invention as mounted to the electric motor and the mounting frame;

FIG. 2B is an exploded side view showing the cooling plate, the electric motor and the mounting frame;

FIG. 3 is an exploded perspective view showing the cooling plate according to the embodiment of the present invention;

FIG. 4 is a schematic sectional view showing an exemplary configuration of a coolant supply channel;

FIG. 5 is a schematic sectional view showing an exemplary configuration of a coolant supply channel; and

FIG. 6 is an exploded perspective view showing a cooling plate according to another embodiment of the present invention.

### DETAILED DESCRIPTION

Embodiments of the present invention will be described below with reference to the accompanying drawings. For clarification of each element in the drawing, the scale of one element in relation to another may be modified from the practical application.

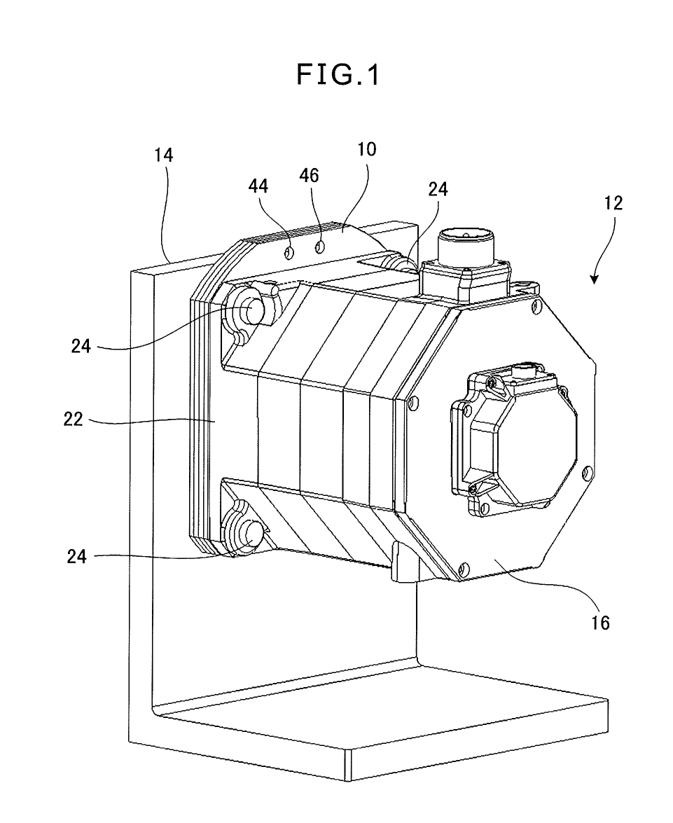

FIG. 1 is a perspective view showing a cooling plate 10 according to an embodiment of the present invention as mounted to an electric motor 12 and a mounting frame 14.

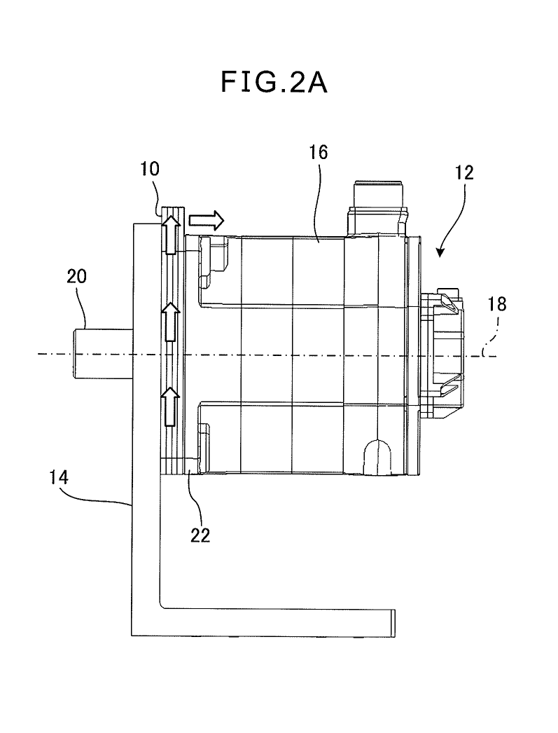

FIG. 2A is a side view showing the cooling plate 10 according to the embodiment as mounted to the electric motor 10 and the mounting frame 14. FIG. 2B is an exploded side view showing the cooling plate 10, the electric motor 12 and the mounting frame 14 shown in FIG. 2A.

The cooling plate 10 is disposed in a fixed manner between the electric motor 12 and the mounting frame 14, as shown in the drawing. The cooling plate 10 is a laminated member including a plurality of plate members stacked on one another. As described below, the cooling plate 10 defines a coolant supply channel in the inside thereof such that a coolant such as cooling water or cooling oil flows through the coolant supply channel while taking heat away from its surroundings. The cooling plate 10 with such cooling capability is mounted in close contact with a casing 16 of the electric motor 12 so as not to conduct heat generated by the electric motor 12 to a machine tool (not shown). The arrows in FIG. 2A schematically show an exemplary heat conductive path.

The electric motor 12 can be a known electric motor. The electric motor 12 as illustrated includes a casing 16 generally having a polygonal column shape, a rotor (not shown) housed in the casing 16 and capable of rotating about an axis 18, and an electromagnet (not shown) for generating a magnetic field to rotate the rotor. Rotational motion of the rotor is used as power to drive a tool of a machine tool in a rotational manner via a shaft 20. The mounting frame 14 is a coupled body interconnected with the electric motor 12, and the electric motor 12 is mounted to the machine tool via the mounting frame 14. A shaft hole 14a is formed in the mounting frame 14 for the shaft 20 to penetrate the electric motor 12. On the side of the mounting hole 14a opposite to the cooling plate 10, a fitted part 14b is formed to be fitted to a convex fitting part 32a of the cooling plate 10, which will be described below.

The casing 16 of the electric motor 12 has a flange 22 generally having a rectangular shape at the end opposite to the cooling plate 10. At each of four corners of the flange 22, a fixing screw 24 is fastened to fix the electric motor 12, the cooling plate 10 and the mounting frame 14 to one another (FIG. 1 only shows three of these fixing screws 24.). The fixing screws 24 extend through the electric motor 12, the cooling plate 10 and the mounting frame 14, respectively. In this embodiment, the fixing screws 24 for mounting the cooling plate 10 also serves as means for fixing the electric motor 12 and the mounting plate member 14 to each other. Thus, an additional fixing means or an additional fixing step for fixing the cooling plate is not required, and the cooling plate 10 can be mounted easily. As a result, productivity can be improved, resulting in a reduction in the manufacturing cost.

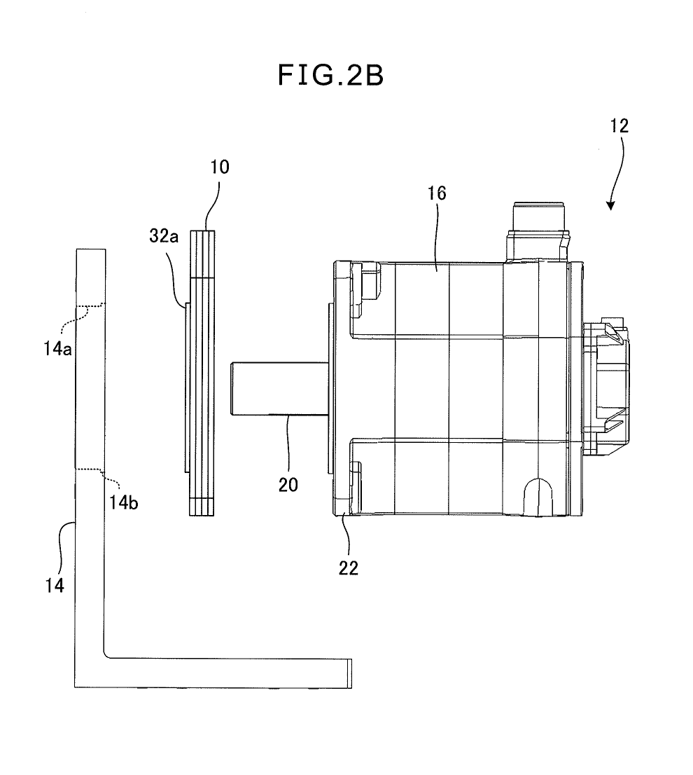

Referring to FIG. 3, the configuration of the cooling plat will now be described below in more detail. FIG. 3 is an exploded perspective view showing the cooling plate 10 according to the embodiment. The cooling plate 10 includes four plate members 26, 28, 30 and 32, as illustrated. Each of these plate members 26, 28, 30 and 32 has a generally rectangular shape, and generally the same outer shape so as to form the cooling plate 10 in a stacked manner. In the center of each plate member 26, 28, 30, 32, a circular shaft hole 34 having the center on the axis 18 is formed, and the shaft 20 of the electric motor 12 extends through these shaft holes 34. At the four corners of each plate member 26, 28, 30, 32, a threaded hole 36 for receiving the above-described fixing screw 24 is formed. In each of the plate members 26, 28, 30 and 32, four through-holes 38 and through-holes 40 having a diameter smaller than that of the threaded hole 36 are formed. These through-holes 38 and 40 are adapted to receive fixing means (not shown) for fixing the plate members 26, 28, 30 and 32 to one another. In this way, the cooling plate 10 can maintain the plate members 26, 28, 30 and 32 in a stacked manner by means of the fixing means.

The first plate member 26 is situated adjacent to the flange 22 of the electric motor 12 when the cooling plate 26 is mounted. That is, in FIGS. 2A and 2B, the first plate member 26 forms the right-most layer of the cooling plate 10. On the surface of the first plate member 26 opposite to the flange 22 of the electric motor 12, a fitted part 42 in the form of an annular concave extends around the shaft hole 34. The fitted part 42 has a complementary shape to a convex part (not shown) formed on the surface of the flange 22 of the electric motor 12. Thus, the fitted part 42 allows the cooling plate to be mounted to the electric motor 12 in close contact therewith, and in addition, it can be used for center alignment between the cooling plate 10 and the electric motor 12. In order to improve accuracy in mounting the cooling plate 10 to the electric motor 12, the surface of the first plate member 26 opposite to the electric motor 12 is preferably processed with a high degree of accuracy. Sufficient accuracy in mounting may be ensured by mounting only the first plate member 26 to the electric motor 12 in advance. With the improved mounting accuracy between the electric motor 12 and the cooling plate 10, rattling noises during operation of the electric motor 12 may be prevented from being produced or a gap between parts may be prevented from being formed over time. Of course, the specific shape of the fitted part 42 may be freely modified depending on the shape of the electric motor 12. For example, the fitted part 42 may protrude toward the electric motor 12. The surface of the first plate member 26 opposite to the second plate member 28 generally has a flat shape such that a penetration groove 48 of the second plate member 28, which will be described below, is closed by the first plate member 26.

In the vicinity of the upper edge of the first plate member 26, an inlet port 44 and an outlet port 46 are formed. A coolant with cooling capability is introduced from the inlet port 44 to the cooling plate 10, and flows through a coolant supply channel, which will be described below, and then is discharged from the outlet port 46. The inlet port 44 and the outlet port 46 are disposed such that they are exposed to the outside when the cooling plate 10 is mounted to the electric motor 12 and the mounting frame 14 (see FIG. 1).

The second plate member 28 and the third plate member 30 are formed by the same member. In the second plate member 28 and the third plate member 30, in addition to the above-described threaded holes 36 and through-holes 38 and 40, penetration grooves 48 and 50 are formed, respectively. The penetration groove 48 extends through the second plate member 28 in a thickness direction and in a plane direction orthogonal to the thickness direction. The penetration groove 48 is a curved groove having plural inflection points. More specifically, the penetration groove 48 includes an inflow end 48a in communication with the inlet port 44 in the thickness direction of the plate member 28, a first circular arc channel 48b, a first inflection point 48c, a second circular arc channel 48d, a second inflection point 48e, a third circular arc channel 48f and an outflow end 48g in communication with the outlet port 46 in the thickness direction of the plate member 28.

Similarly to the penetration groove 48, a penetration groove 50 formed in the third plate member 30 includes an inflow end 50a in communication with the inlet port 44 in a thickness direction of the plate member 30, a first circular arc channel 50b, a first inflection point 50c, a second circular arc channel 50d, a second inflection point 50e, a third circular arc channel 50f and an outflow end 50g in communication with the outlet port 46 in the thickness direction of the plate member 30. The penetration grooves 48 and 50 define one coolant supply channel by joining the second plate member 28 and the third plate member 30 to each other.

The surface of the fourth plate member 32 opposite to the third plate member 30 generally has a flat shape so as to close the above-described penetration groove 50 of the third plate member 30. On the surface of the fourth plate member 32 opposite to the mounting frame 14, a generally circular fitting part 32a protruding toward the mounting frame 14 as illustrated in FIG. 2A is formed. The external shape of the fitting part 32a is adapted to the fitted part 14b generally having a circular shape formed in the mounting frame 14. This allows for close fitting between the cooling plate 10 and the mounting frame 14. The fitting part 32a and the fitted part 14a can be used for center alignment between the cooling plate 10 and the mounting frame 14 when they are fixed to each other. The surface of the fourth plate member 32 opposite to the mounting frame 14 is preferably processed with a high degree of accuracy similarly to the surface of the first plate member 26 opposite to the electric motor 12. With the improved accuracy in mounting the cooling plate 10 and the mounting frame 14 to each other, rattling noises during an operation of the electric motor 12 may be prevented from being produced or a gap between parts may be prevented from being formed over time.

In this way, the cooling plate 10 defines one coolant supply channel formed by stacking the second plate member 28 and the third plate member 30 having the penetration grooves of the same shape on each other, and both sides of the coolant supply channel are closed by the first plate member 26 and the fourth plate member 32. With the configuration, as compared to a coolant supply channel formed by a single plate member, the cross sectional area of the coolant supply channel can be doubled. This allows a flow rate of the coolant to be increased, and the enhanced cooling effect can be achieved.

In accordance with the embodiment of the present invention, the coolant supply channel is formed by the penetration grooves formed in the plate members. A step of forming such penetration grooves in a plate member can be carried out by pressing, in particular, by punching. Therefore, for example, as compared to machine-cutting used in forming a concave groove in a plate member, a coolant supply channel can be formed more easily. In other words, according to the present invention, the cooling plate can be manufactured more efficiently, and as a result, an inexpensive cooling plate can be provided. The plate members may also be formed by casting using a metal mold, such as aluminum die casting.

In accordance with the embodiment of the present invention, a coolant supply channel having a larger cross sectional area can be formed by combining a plurality of plate members. Although the exemplary two penetration grooves 48 and 50 superimposed on one another have been described above, modified combination of the plate members may also be possible by stacking three or more of the plate members on one another. In this way, the cooling effect can be finely adjusted by changing the combination of the plate members to form the cooling plate.

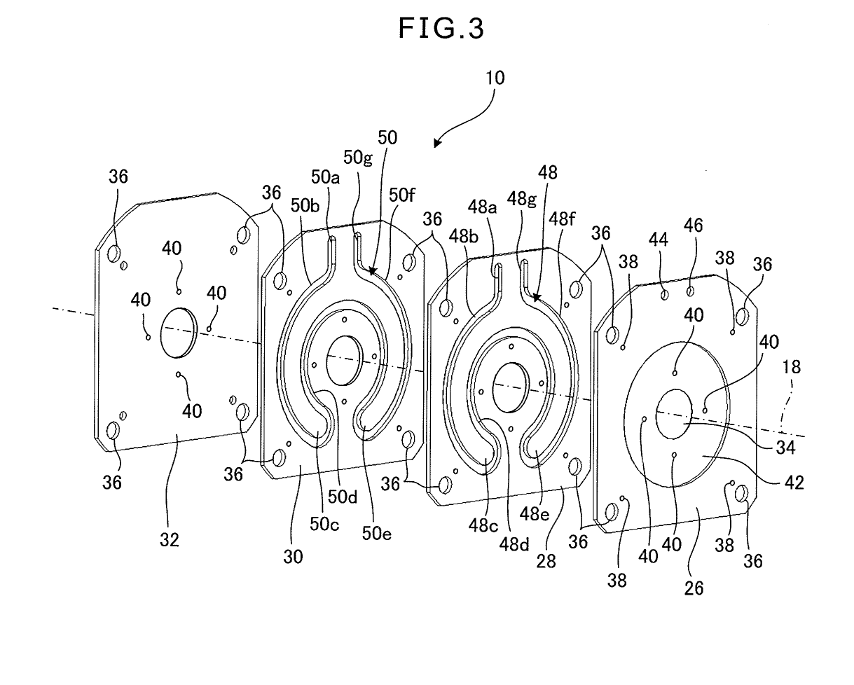

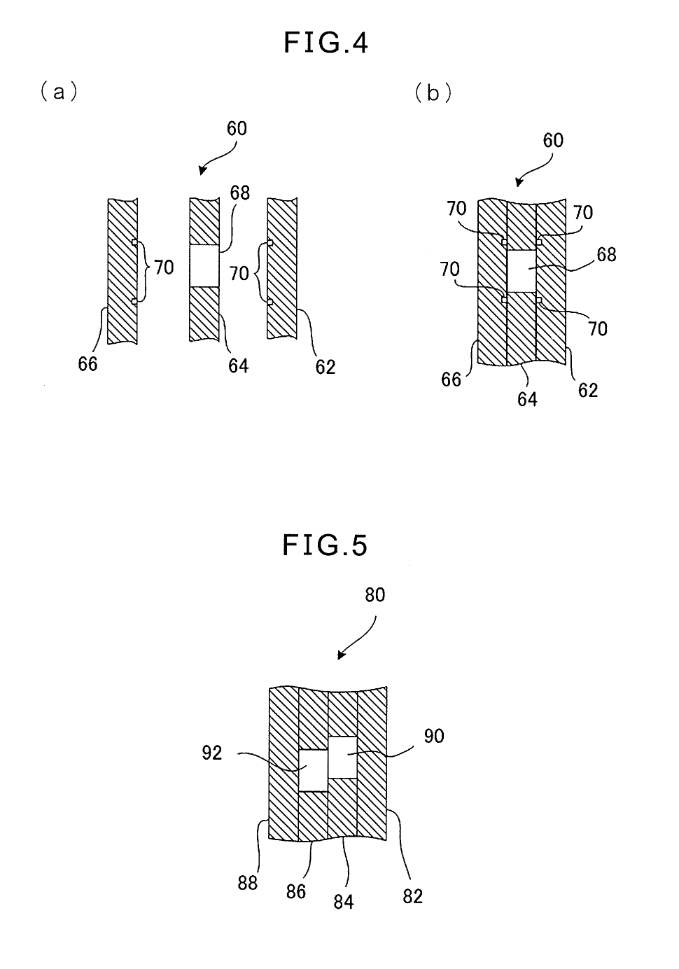

Another embodiment of the present invention will now be described below with reference to FIGS. 4 and 5. FIGS. 4 and 5 schematically show a section of an exemplary configuration of a coolant supply channel, respectively. In these drawings, only partial sections of penetration grooves 68, 90 and 92 are schematically illustrated for the sake of simplicity.

A cooling plate 60 shown in FIG. 4 includes a first plate member 62, a second plate member 64 and a third plate member 66. In this embodiment, a penetration groove is formed only in the second plate member 64. The first plate member 62 has a similar configuration to that of the first plate member 26 described above with reference to FIG. 3. The second plate member 64 has also a similar configuration to that of the second plate member 28 or the third plate member 30 described above with reference to FIG. 3. The third plate member 66 has a similar configuration to that of the fourth plate member 32 described above with reference to FIG. 3. As in the present embodiment, when a sufficient cooling effect can be achieved by a coolant supply channel having a cross sectional area corresponding to the thickness of one plate member, a minimum number of plats is required to assemble the cooling plate 60, reducing the material cost. Accordingly, only a plate member having a thickness corresponding to the width of a required coolant supply channel is required, and not only can plate member materials be prevented from being wasted, but also inexpensive plate members having a relatively small thickness can be used.

As illustrated, a sealing groove 70 is formed in the first plate member 62 and the third plate member 66, and sealing means such as sealing resin is filled in the sealing groove 70. By providing such sealing means, even if a gap may be formed between the plate members 62, 64 and 66 of the cooling plate 60, leakage of the coolant can be prevented. The manner in which sealing is provided between the plate members is not limited to this particular type, but any other known sealing means may be used. For example, the plate members may be welded together to close the gap therebetween. Although not specifically mentioned, such additional sealing means of the cooling plate may also be used in other embodiments.

A cooling plate 80 according to an embodiment shown in FIG. 5 includes a first plate member 82, a second plate member 84, a third plate member 86 and a fourth plate member 88. The first plate member 82 has a similar configuration to that of the first plate member 26 described above with reference to FIG. 3. The fourth plate member 88 has a similar configuration to that of the fourth plate member 32 described above with reference to FIG. 3. In the second plate member 84 and the third plate member 86, penetration grooves 90 and 92 are formed, respectively, to have a similar shape to that the penetration groves 48 and 50 in the second plate member 28 and the third plate member 30 described above with reference to FIG. 3. However, in this embodiment, one penetration groove 90 is formed so as to be offset relative to the other penetration groove 92 in a plane direction of the plate member. The penetration grooves 90 and 92 are formed to be displaced in relation to each other such that, when the plate members 84 and 86 are stacked on each other, they are positioned to be offset relative to each other. With the configuration, the surface area of the coolant supply channel is increased, so that heat exchange with the coolant can be made more effectively, and as a result, the enhanced cooling effect can be achieved. The penetration grooves 90 and 92 may be formed so as to be offset entirely, or may be formed so as to be offset to each other locally only at positions where temperature tends to become higher.

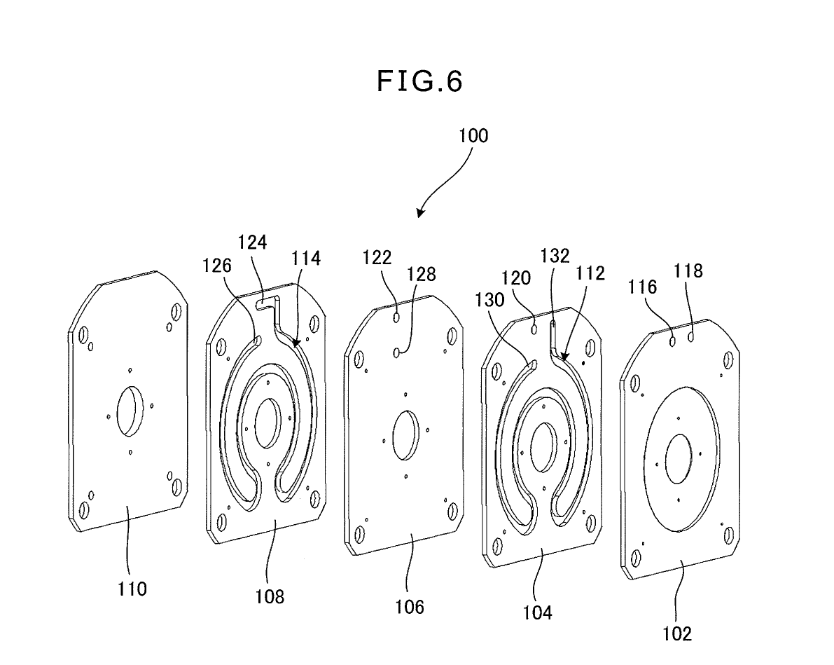

Referring to FIG. 6, another embodiment of the present invention will be described. FIG. 6 is an exploded perspective view showing a cooling plate 100 according to this embodiment. The cooling plate 100 includes a first plate member 102, a second plate member 104, a third plate member 106, a fourth plate member 108 and a fifth plate member 110. The first plate member 102 has a similar configuration to that of the first plate member 26 described above with reference to FIG. 3. The fifth plate member 110 has a similar configuration to that of the fourth plate member 32 described above with reference to FIG. 3. In the second plate member 104 and the fourth plate member 108, penetration grooves 112 and 114 are formed, respectively, to have a similar shape to that of the second plate member 28 and the third plate member 30 described above with reference to FIG. 3. However, unlike the embodiment shown in FIG. 3, the third plate member 106 is interposed between the second plate member 104 and the fourth plate member 108, and therefore, the penetration groves 112 and 114 are not configured to be superimposed on each other. Specifically, the surface of the third plate member 106 opposite to the second plate member 104 and the surface of the third plate member 106 opposite to the fourth plate member 108 generally have a flat shape such that the penetration groves 112 and 114 are closed in a thickness direction, respectively.

In the vicinity of the upper edge of the first plate member 102, an inlet port 116 and an outlet port 118 are formed. In the vicinity of the upper edge of the second plate member 104, a first inlet communication hole 120 in communication with the inlet port 116 is formed. The first inlet communication hole 120 is in communication with an inlet side end 124 of the penetration groove 114 of the fourth plate member 108 via a second inlet communication hole 122 formed in the third plate member 106. An outlet side end 126 which is at the end of the penetration groove 114 opposite of the inlet side end 124 is in communication with an inlet side end 130 of the penetration groove 112 of the second plate member 104 via an outlet communication hole 128 formed in the third plate member 106. An outlet side end 132 which is at the end of the penetration groove 112 opposite of the inlet side end 130 is further in communication with the outlet port 118 of the first plate member 102. Accordingly, in the present embodiment, a coolant entering at the inlet port 116 flows through the first inlet communication hole 120, the second inlet communication hole 122, the penetration groove 114, the outlet communication hole 128 and the penetration groove 112 in this order, and is discharged from the outlet port 118.

In accordance with the present invention, a plurality of the penetration grooves extending in a plane direction of plate members are arranged so as to be spaced apart from each other in a thickness direction of the plate members. With this configuration, a cooling action through heat exchange with the coolant can be provided in a stepwise manner. Therefore, the cooling action can be effectively increased without additional complex means.

Although the present invention has been described above with reference to the various exemplary embodiments thereof, in order to implement the present invention, the features described above with reference to these embodiments may be combined or may be omitted as necessary, as long as there is no technical inconsistency.

### Effect of the Invention

In accordance with the first aspect of the present invention, the coolant supply channel is defined by the penetration groove extending through the plate member. The penetration groove can be easily formed, for example, by pressing, in particular, by punching, and therefore, an inexpensive cooling plate can be provided. Since only plate members having a thickness corresponding to the width of the coolant supply channel are required, plate materials can be prevented from being wasted, reducing the material cost. In addition, in accordance with this aspect, two or more plate members having a penetration groove may be provided as necessary, and the coolant supply channel can be formed by the penetration grooves. With such a configuration, the cross section of the coolant supply channel can be easily modified so as to increase a flow rate of the coolant, and the enhanced cooling effect can be achieved.

In accordance with the second aspect of the present invention, since the penetration grooves are formed in a plurality of plate members, the enhanced cooling effect can be achieved. The cooling effect can be finely adjusted simply by modifying the shape of the penetration grooves or the arrangement of the plate members having the penetration grooves.

In accordance with the third aspect of the present invention, leakage of the coolant through the gap formed between the plate members stacked on one another.

In accordance with the fourth aspect of the present invention, the improved accuracy in mounting the electric motor and the cooling plate to each other, and the improved accuracy in mounting the coupled body and the cooling plate to each other can be achieved. Therefore, rattling noises during an operation of the electric motor can be prevented from being produced and a gap formed between parts can be prevented from being formed over time.

In accordance with the fifth aspect of the present invention, the step of interconnecting the electric motor, the cooling plate and the coupled body can be carried out at the same time by means of common fixing means. Therefore, an additional step of fixing the cooling plate is not required, and the increased productivity can be achieved, and as a result, the manufacturing cost can be reduced.

Although the invention has been shown and described with exemplary embodiments thereof, it should be understood by those skilled in the art that the foregoing and various other changes, omissions and additions may be made therein without departing from the spirit and scope of the invention.

What is claimed is:

1. A cooling plate comprising a plurality of plate members stacked on one another between an electric motor and a coupled body to which the electric motor is coupled, wherein at least one of the plurality of plate members has a penetration groove extending through the plate member in a thickness direction and extending in the plate member in a plane direction orthogonal to the thickness direction, the penetration groove defining a coolant supply channel for supplying a coolant.

2. The cooling plate according to claim 1, wherein at least two of the plurality of plate members have the penetration groove, the penetration grooves being in communication with one another and forming the coolant supply channel.

3. The cooling plate according to claim 1, further comprising seal means for sealing the coolant supply channel.

4. The cooling plate according to claim 1, wherein one of the plurality of plate members situated opposite to the electric motor has a surface adapted to an opposite surface shape of the electric motor, and wherein
one of the plurality of plate members situated opposite to the coupled body has a surface adapted to an opposite surface shape of the coupled body.

5. The cooling plate according to claim 1, further comprising a receiving portion for receiving fixing means for fixing the electric motor, the cooling plate and the coupled body to one another.
